(19) United States
(12) Patent Application Publication
(10) Pub. No.: US 2010/0322401 A1
(43) Pub. Date: Dec. 23, 2010

(54) METHODS FOR TRANSMITTING IMAGE OF PERSON, DISPLAYING IMAGE OF CALLER AND RETRIEVING IMAGE OF PERSON, BASED ON TAG INFORMATION

(75) Inventor: Jung-hee Ryu, Seoul (KR)

Correspondence Address: HUSCH BLACKWELL LLP, 190 Carondelet Plaza, Suite 600, ST. LOUIS, MO, 63105, US

(73) Assignee: OLAWORKS, INC., Seoul (KR)

(21) Appl. No.: 12/526,314

(22) PCT Filed: Feb. 5, 2008
(86) PCT No.: PCT/KR2008/000758

§ 371 Date: Aug. 7, 2009

(30) Foreign Application Priority Data
Feb. 8, 2007 (KR) 10-2007-0013041

(51) Int. Cl. H04M 15/06; G06F 17/30

(52) U.S. Cl. 379/142.06; 707/780; 707/E17.014

(57) ABSTRACT

A method for transmitting an image of a person based on tag information, includes the steps of: acquiring an image of a specific person; retrieving an address related to the specific person from tag information attached to the image of the specific person; and transmitting the image of the specific person to the retrieved address. As a result, the user can easily transmit the image of the person to one who has relation to the person. Moreover, methods for displaying an image of a caller, and retrieving images of a desired person based on the tag information is also disclosed.

### TECHNICAL FIELD

The present invention relates to various services provided on the basis of tag information and, more particularly, to a method enabling a user to easily transmit an image of a person to the person's terminal based on tag information, a method for displaying, on a screen, a caller's image while the telephone is ringing based on the tag information, and a method for retrieving and classifying images of a specific person based on the tag information.

### BACKGROUND ART

The latest technologies, e.g., Web 2.0, have aimed at the openness, the mobility and the connectivity of information. In order to realize the openness, the mobility and the connectivity, the information is required to be retrieved without delay.

However, it is not easy to retrieve image-based (or multimedia-based) information unlike text-based information. Therefore, considerable research has been conducted on efficient methods for retrieving images. Moreover, for the efficient retrieval of the image (or multimedia content), the research has also been conducted on techniques for systemically attaching appropriate tag information to the image.

For example, if tag information is given to an image of a specific person, the image of the specific person can be easily retrieved and used in diverse applications.

In general, a device, capable of searching, sending and receiving an image of a person, may be a desktop, a notebook computer, or a small-sized mobile device such as a portable phone. While a mobile device is portable due to its small size, it is inconvenient to handle because it is operated by using a keypad or a touchpad with a small number of keys.

The tendency toward digital convergence provides a camera function to most mobile devices. A user may take his or her own image or an image of a friend by using the mobile device. In case the image of the friend is taken, the user may want to transmit the image to the very same friend.

Meanwhile, the user (i.e., the callee) may want an image of a caller displayed through a screen of a user's phone, while the phone is ringing.

Further, the user may want to sort all images in order to see images of a specific friend.

### DISCLOSURE OF INVENTION

### Technical Problem

However, the user should press the keypad or the touchpad many times inconveniently for the above-mentioned diverse applications, because the performance of the keypad or the touchpad of the mobile device is restricted. Accordingly, there is a need for a convenient method for handling the image of the person by using the keypad or the touchpad of the mobile device.

### Technical Solution

It is, therefore, one object of the present invention to provide a method enabling a user to easily transmit an image of a specific person to the very same specific person (or other person who has relation to the specific person), based on tag information.

It is another object of the present invention to provide a method for displaying an image of a callee or a caller on a screen of a terminal when the user calls or receives the phone call, based on the tag information.

It is yet another object of the present invention to provide a method for easily retrieving and classifying one or more images related to a specific person, based on the tag information.

However, the objects of the present invention are not limited to the foregoing.

### ADVANTAGEOUS EFFECTS

In accordance with the present invention, even when a mobile device with a restrictive input unit is used, the user can be provided with various convenient services related to an image of a person.

In accordance with the present invention, the user can easily transmit an image of a specific person to the specific person without difficultly in finding a contact address of the specific person.

In accordance with the present invention, when a user (i.e., a callee) receives a telephone call from a caller, the image of the caller may be variously displayed based on predetermined rules even though the user does not determine one by one which image will be displayed.

In accordance with the present invention, the user can easily retrieve images of a specific person from a plurality of images recorded in a database.

### BRIEF DESCRIPTION OF THE DRAWINGS

The above objects and features of the present invention will become more apparent from the following description of the preferred embodiments given in conjunction with the accompanying drawings, in which:

FIG. 1 is a flowchart illustrating a process of providing services using tag information;

FIG. 2 shows a flowchart illustrating a process of attaching tag information to a digital data, e.g., an image of a person;

FIG. 3 illustrates a state of selecting a specific person, i.e., a woman, among a plurality of persons included in an image to attach tag information on the specific person to the image; and states of displaying images of candidates to easily attach tag information to an image of the specific person;

FIG. 4 depicts a block diagram showing a hardware configuration of a device for providing various services in accordance with the present invention;

FIG. 5 shows a block diagram illustrating a software configuration of the device for providing various services in accordance with the present invention;

FIG. 6 is a flowchart illustrating a service of transmitting an image of a person to the very same person based on tag information;

FIG. 7 is a flowchart presenting a service of displaying an image of a caller on a screen of a callee's terminal when the callee receives a telephone call, based on tag information; and

FIG. 8 is a flowchart illustrating a service of retrieving one or more images of a specific person, based on tag information.

### BEST MODE FOR CARRYING OUT THE INVENTION

The configurations of the present invention for accomplishing the above objects of the present invention are as follows.

In one aspect of the present invention, there is provided a method for transmitting an image of a person based on tag information, including the steps of: acquiring an image of a specific person; retrieving an address related to the specific person from tag information attached to the image of the specific person; and transmitting the image of the specific person to the retrieved address.

In another aspect of the present invention, there is provided a method for displaying an image of a caller based on tag information, including the steps of: receiving a call from the caller; retrieving tag information which corresponds to the call; and displaying one or more images corresponding to the retrieved tag information.

In yet another aspect of the present invention, there is provided a method for displaying an image of a callee based on tag information, including the steps of: transmitting a call to the callee; retrieving tag information which corresponds to the call; and displaying one or more images corresponding to the retrieved tag information.

In yet still another aspect of the present invention, there is provided a method for retrieving one or more images of a specific person based on tag information from a database where a plurality of images are recorded, including the steps of: providing a certain image of the specific person; acquiring first tag information corresponding to the certain image of the specific person; retrieving second tag information having the same identification information as that of the acquired first tag information; and providing one or more images corresponding to the first or the second tag information.

### MODE FOR THE INVENTION

In the following detailed description, reference is made to the accompanying drawings that show, by way of illustration, specific embodiments in which the present invention may be practiced. These embodiments are described in sufficient detail to enable those skilled in the art to practice the present invention. It is to be understood that the various embodiments of the present invention, although different from one another, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The embodiments of the present invention will be described, in detail, with reference to the accompanying drawings.

In accordance with the present invention, a term “tag information” (or “image tag information”) may be understood as one or more tags which include information related to and attached to an image of a person. For example, if an image of a specific person is considered, the tag information may include a name, a telephone number, an address, an email address, a nickname etc. of the specific person. In this case, the term “tag information” may also be called as “person tag information”.

In some case, one tag may be given to one image. However, in case a plurality of persons are included in an image, either one tag which has information on the plurality of persons or a plurality of tags, each of which has relation to each person included in the image, may be attached to the image.

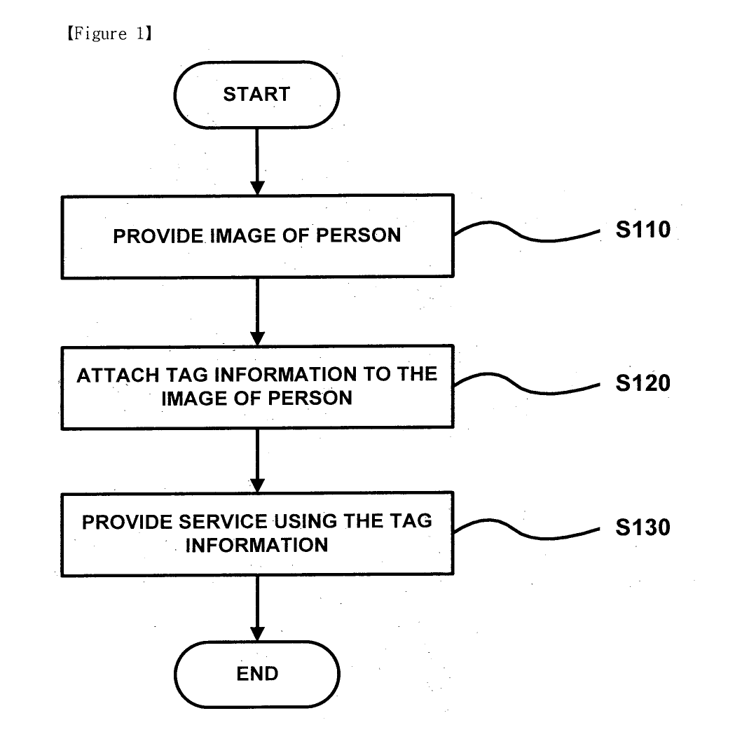

FIG. 1 is a flowchart illustrating a process of providing services to a user using the aforementioned tag information in accordance with the present invention.

At step S110, a service device acquires an image of a person. The image may be acquired by either directly taking a picture of the person by using the service device itself or indirectly receiving it from other devices outside of the service device.

After the image of the person is acquired, the service device attaches tag information to the image at step S120. If the tag information is provided to the service device along with the image of the person from the outside, the service device may not newly attach any tag information to the image of the person.

Then, the service device records in a database the image of the person and the tag information attached thereto.

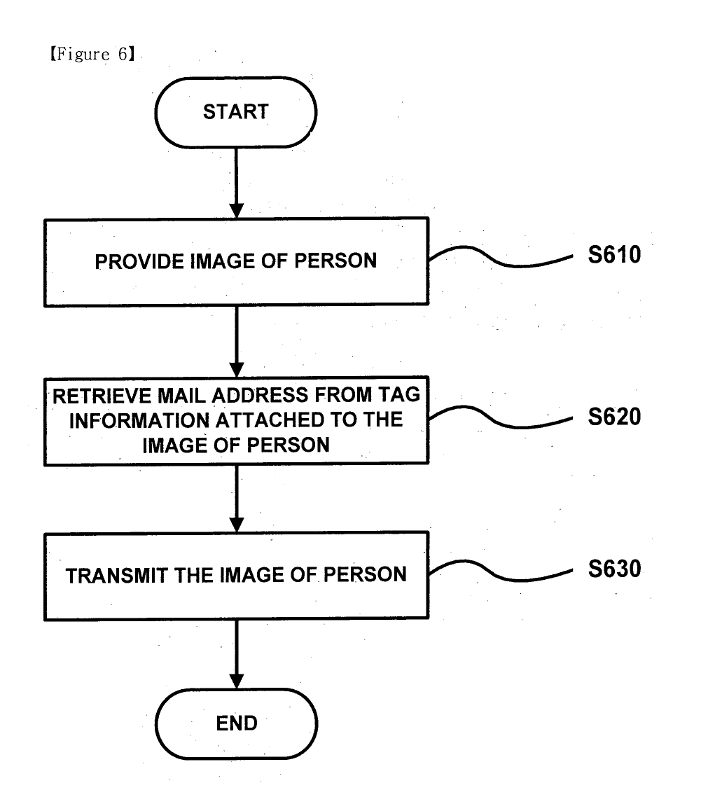

At step S130, the service device provides various services to the user by using the tag information given to the image of the person. Examples of the various services will be described later, in detail, with reference to FIGS. 6, 7 and 8. In short, the service device may provide a service of transmitting an image A1 to a person A2 who appears in the image A1; a service of displaying at least one image B2 related to a person B1 at the time of phone call from the person B1; and a service of retrieving images C3 having the same identification information as that of an image C1 of a person C2. The service device provides these services by using the tag information.

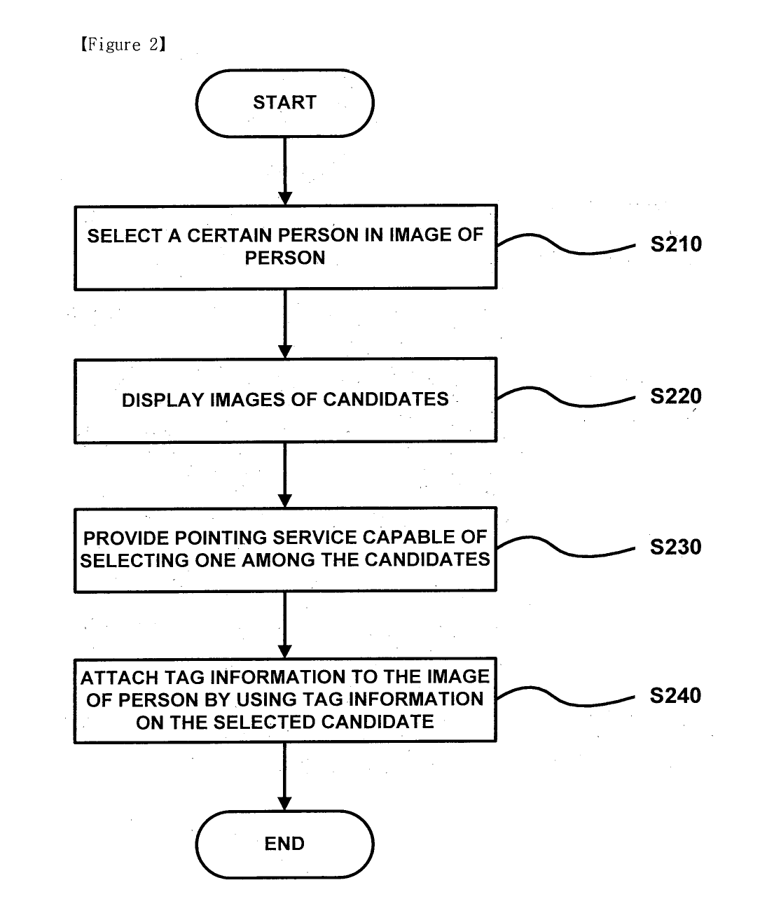

FIG. 2 shows a flowchart illustrating a process of attaching the tag information to an image of a person in accordance with the present invention.

At step S210, the service device selects a specific person in the image.

In case a plurality of persons are included in the image, the specific person may be selected among the plurality of the persons to attach the tag information on the specific person to the image.

Meanwhile, in case only one person is included in the image, the very same person may be selected automatically. In this case, the step S210 for selecting the specific person may be omitted.

Thereafter, at step S220, the service device retrieves from a database a plurality of images of candidates having high probabilities of being determined as the specific person, and then displays the retrieved images of the candidates. A technique for providing a plurality of the candidates (i.e., Top N list), having the top N probabilities of being determined as the specific person included in the acquired digital data, is disclosed in Korean Patent Application No. 10-2006-0077416 filed on Aug. 17, 2006 (which was also filed in PCT international application No. PCT/KR2006/004494 on Oct. 31, 2006) by the same applicant as that of the present invention, entitled “Methods for Tagging Person Identification Information to Digital Data and Recommending Additional Tag by Using Decision Fusion”.

After displaying the images of the candidates, the service device provides the user with a pointing service (step S230). The user can select a desired image among the images of the candidates by using the pointing service.

If the user selects the desired image, the service device attaches tag information, having been attached to the desired image, to the image of the specific person (step S240). For example, the service device may attach the tag information, e.g., a name, an email address, a telephone number etc. of the candidate included in the desired image, to the image of the specific person.

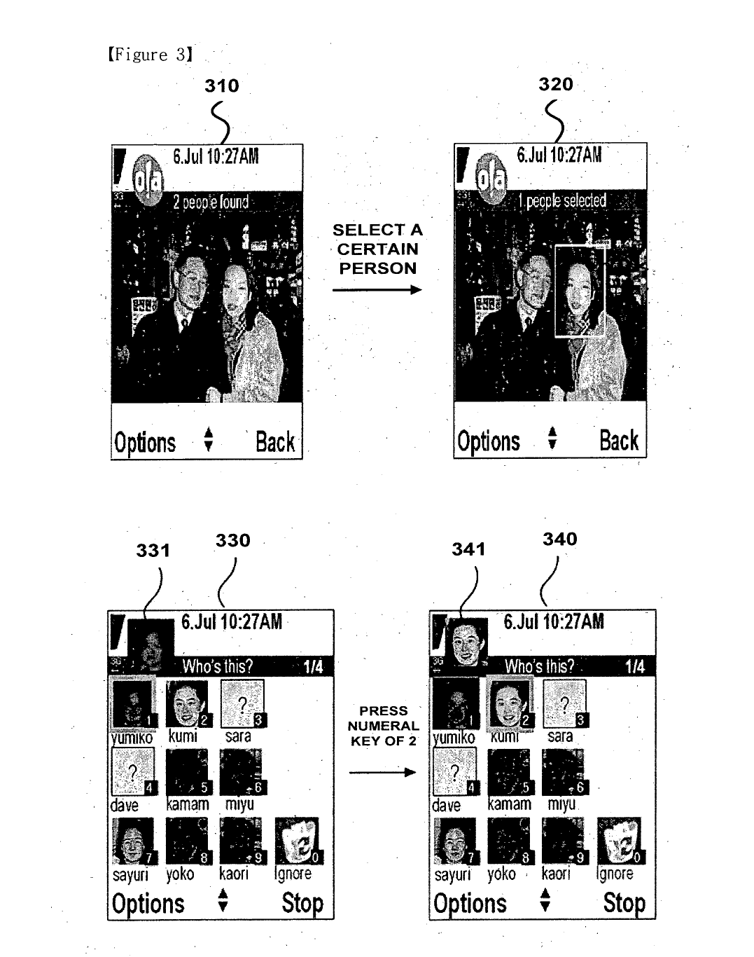

FIG. 3 illustrates a state 320 of selecting a specific person, i.e., a woman, among a plurality of persons included in an image 310 to attach tag information on the specific person to the image 310; and states 330 and 340 of displaying images of candidates to easily attach tag information to an image of the specific person.

As illustrated in the states 330 and 340, the images (and/or the names) of nine candidates may be displayed in the form of, e.g., 3*3 matrix on a screen. Displaying the images of the candidates in the form of 3*3 matrix enables the user to more easily select the specific candidate, in case an input unit of a mobile phone is a sort of a keypad. For example, if the keys corresponding to numerals 1 to 9 in the keypad of the mobile phone are arranged in the form of 3*3 matrix, there is a one-to-one correspondence between the displayed images of the nine candidates and the keys of the keypad, so that the user can easily select any candidate by pressing an appropriate key.

Further, if the keys in the keypad are arranged in the form of p*q matrix, the images of the candidates may be also displayed in the form of p*q matrix in order to achieve a one-to-one correspondence therebetween.

As illustrated in the states 330 and 340, the images of the candidates may be displayed along with their names. For example, an image of a first candidate is displayed along with a name of “Yumiko.”

Moreover, as shown in a screen 330 of the service device, an image, e.g., the image of the first candidate, may be highlighted. Further, the image of the highlighted candidate may be also displayed in a separate region 331.

As described above, the service device provides the user with the pointing service so that the user can select any one of the displayed images of the candidates. That is, the user can change the location of the highlighted region by manipulating the keys in order to select any one of the displayed images of the candidates. For example, if the user presses a ‘2 ’ key at the time when the image of the first candidate is highlighted, the location of the highlighted region may be moved to a second candidate (an image of the second candidate, i.e., “Kumi”, becomes highlighted). Referring to a screen 340 on which the image of the second candidate is highlighted, the image of the second candidate may be also displayed in a separate region 341.

On the other hand, the user can select one of the candidates by moving the highlighted region by manipulating arrow keys provided to most mobile phones. For example, at the time when the image of the first candidate is highlighted, the user may move the highlighted region to the image of the second candidate by pressing the right arrow key.

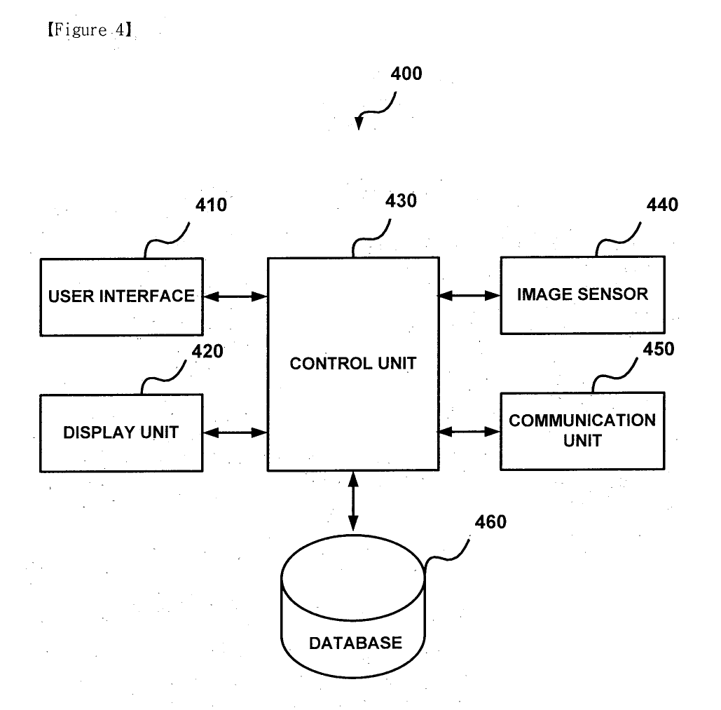

FIG. 4 depicts a block diagram showing a hardware configuration of a service device 400 for providing various services to users in accordance with the present invention.

The service device 400 includes a user interface 410, a display unit 420, a control unit 430, a CMOS Image Sensor (CIS) module 440, a communication unit 450 and a database 460.

The user interface 410 receives a command inputted by a user and transmits the command to the control unit 430. The user interface 410 may include a keypad or a touchpad. By using the user interface 410, the user can order the service device 400 to execute the command or select an image of a candidate.

The display unit 420 displays the acquired image of a person (or persons) or a plurality of images of candidates.

The CIS module 440 converts optical signals into electrical signals, to thereby create an image of a person. The CIS module 440 may include a lens, an image sensor, an Analog to Digital Converter (ADC), a noise filter and the like.

The communication unit 450 is provided to enable an audio communication and a transmission of an image of a person. To make possible these functions, the communication unit 450 may include a line-based communication module, such as a cellular-based communication module, or a packet-based communication module, such as a Voice over Internet Protocol (VoIP) module.

The acquired images of persons and tag information attached thereto may be recorded in the database 460. Further, the images of candidates and tag information attached thereto may be also recorded in the database 460.

The control unit 430 may control the above-mentioned elements 410, 420, 440, 450, 460 included in the service device 400 by using installed various drivers, operating systems, application programs and the like.

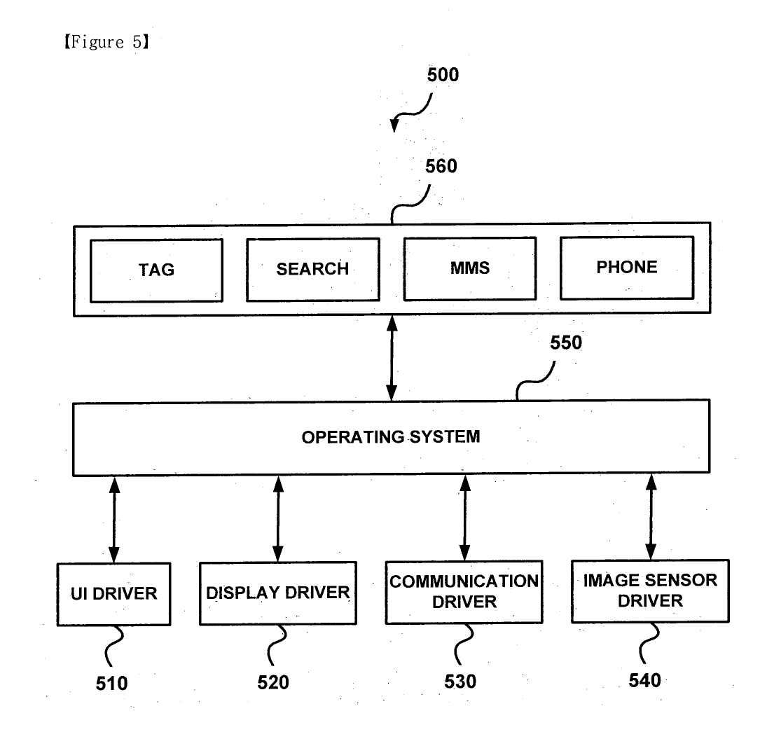

FIG. 5 shows a block diagram illustrating a software configuration 500 for providing various services in accordance with the present invention.

The software configuration 500 of the service device includes a plurality of drivers 510, 520, 530, 540, an operating system 550, and an application program 560 for operating the every element of the service device.

The user interface (UI) driver 510 is the program including a routine required to operate the user interface 410.

The display driver 520 is the program including a routine required to operate the display unit 420.

The communication driver 530 is the program including a routine required to operate the communication unit 450.

The CIS driver 540 is the program including a routine required to operate the CIS module 440.

The application program 560 performs each programmed function based on the services provided by the operating system 550. The application program 560 includes programs for performing each function.

A TAG program includes a service routine required to attach tag information to an image of a person.

A SEARCH program includes a service routine required to retrieve a plurality of images related to a specific person.

An MMS program includes a service routine required to transmit an image of a person.

A PHONE program includes a service routine required to display an image corresponding to a caller's telephone number at the time of phone call from the caller.

Each of the above-described programs may be embodied separately, but the above-described programs may be embodied by integrating them with other programs. Further, each of the programs may be embodied by dividing it into a plurality of sub-programs.

FIG. 6 illustrates a process of transmitting an image of a specific person to the specific person based on tag information in accordance with an example embodiment of the present invention.

At step S610, a service device, e.g., a mobile phone or a portable device, acquires digital data including an image of the specific person. The image may be acquired by either directly taking a picture of the specific person by using the service device itself or indirectly receiving it from other devices outside of the service device. Herein, the tag information may or may not have been attached to the acquired image.

At step S620, the service device retrieves, e.g, an email address from the tag information attached to the image of the specific person. It is also possible to retrieve a telephone number, a web service ID, a fax number, a residence and the like from the tag information. However, the description will be presented by limiting targets of the retrieval to the email address, for convenience' sake.

In case the tag information has been attached to the acquired image of the specific person, the service device can retrieve the email address from the tag information.

However, in case the tag information has not been attached to the acquired image of the specific person, the service device may retrieve the email address after newly attaching the tag information to the acquired image of the specific person, as described with respect to FIG. 2.

The service device retrieves from the database a plurality of images of candidates having high probabilities of being determined as the specific person included in the acquired image and then displays the retrieved images of the candidates. For example, as illustrated in FIG. 3, the images (and/or the names) of nine candidates may be displayed in the form of 3*3 matrix on a screen.

The service device provides a user with a pointing service so that the user can select a desired image among the images of the candidates. However, in case none of the displayed nine candidates is considered to be identical with the specific person, the user may order the service device to display images (and/or names) of a next group of candidates having the next highest probabilities.

If the user selects the desired image including a candidate who is considered to be identical with the specific person, the service device retrieves an email address from tag information having been attached to the selected desired image.

Accordingly, by retrieving the email address from the tag information, it is not necessary for the user to input the email address one by one by using the keypad inconveniently.

At step S630, the service device transmits the image of the specific person to the email address which has been retrieved through the above-described process. For example, the service device may transmit the image of the specific person by using a Multimedia Messaging Service (MMS). Herein, if, instead of the email address, the telephone number, the web service ID, the fax number, the residence, etc., are retrieved from the tag information, the image of the specific person may be transmitted to the very same telephone number, the very same web service ID, the very same fax number, the very same residence and the like.

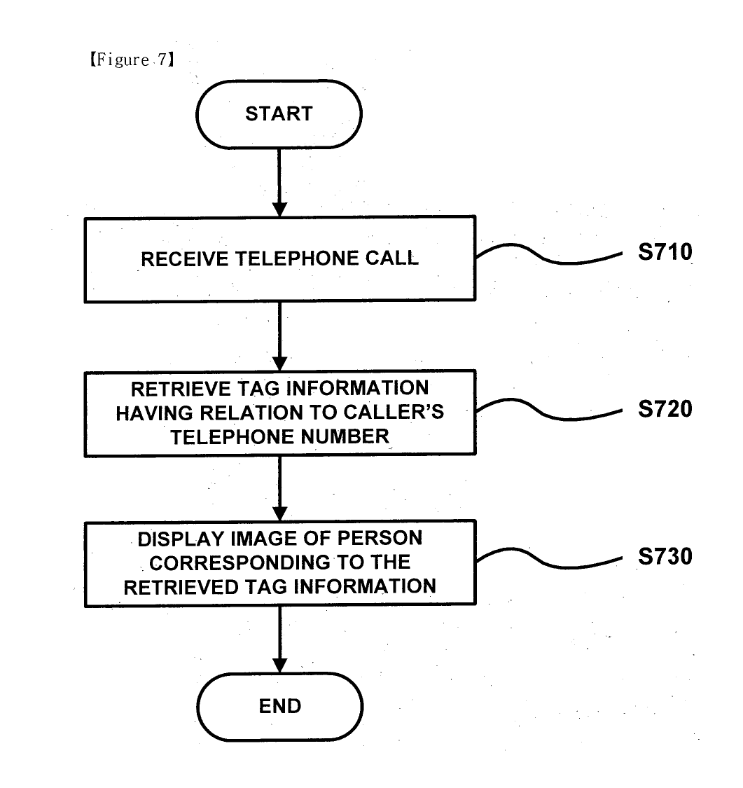

FIG. 7 provides a process of displaying an image of a caller on a screen of a user's terminal when the user receives a telephone call from the caller, based on the tag information in accordance with another example embodiment of the present invention. On the other hand, when the user calls a certain person, an image of the certain person may be displayed on the screen of the user's terminal. Hereinafter, the description will be presented about the former case for convenience' sake.

At step S710, the service device receives a telephone call from a caller. At this step, not only a telephone call, but also an SMS, a mobile email, an MMS and the like may be applied. However, the following description will be focused on the case of receiving the telephone call as an example.

After receiving the telephone call, the service device retrieves tag information corresponding to the caller's telephone number at step S720.

For example, in case there are various telephone numbers in the tag information attached to images recorded in the terminal, the service device retrieves tag information about the caller's telephone number among all the tag information.

However, in case there is no telephone number in the tag information attached to the images recorded in the terminal, the service device retrieves the caller's telephone number from a so-called telephone directory (or an address book) recorded in the terminal. After retrieving the caller's telephone number from the telephone directory, the service device may acquire identification information on the caller. The identification information may include a name, an address, an email address, a nickname and the like. Thereafter, the service device may retrieve other tag information which includes the very same identification information on the caller.

If all the tag information associated with the caller is retrieved, the service device displays one or more images corresponding to the retrieved tag information at step S730.

In case only one image corresponds to the retrieved tag information, the very same image may be displayed whenever the telephone call is received from the caller.

However, in case a plurality of images correspond to the retrieved tag information, it is necessary to determine which image will be displayed among the plurality of images when the telephone call is received from the caller.

If one example is considered, the service device may display a certain image having the latest updated tag information among the plurality of the images. That is, when the telephone call is received from the caller, the service device displays the latest updated image, thereby making the user feel fresh.

If another example is considered, the service device may randomly select one image among the plurality of images to display it.

If still another example is considered, the service device may display the plurality of images one by one at regular intervals while the telephone is ringing. For example, if five images are retrieved with respect to the caller, the service device can change an image which is being displayed among the five images every one second while the telephone is ringing.

If yet still another example is considered, the number of times of the telephone call received from the caller is increased, the service device may change an image which is going to be displayed among the plurality of images. For example, if five images, e.g., A, B, C, D and E, associated with the caller are retrieved, when the telephone call is received from the caller for the first time, the service device may display the image A. Further, when the telephone call is received from the caller for the second time, the service device may display the image B. Likewise, when the telephone call is received from the caller for the third time, the service device may display the image C; when the telephone call is received from the caller for the fourth time, the service device may display the image D; and when the telephone call is received from the caller for the fifth time, the service device may display the image E.

Thereafter, if the telephone call is received from the caller for the sixth time, the service device may display the image A again.

To display the plurality of images one by one as mentioned above, if the telephone call is received, the service device may display a certain image, which has not been displayed for the longest time, among the plurality of images. Then, the service device may record the fact that the certain image has been displayed for a current telephone call. In this case, the service device may record the fact either directly in the tag information attached to the certain image or indirectly in a separate memory other than the tag information. The fact may include the information on the time when the certain image was displayed but it may not be limited thereto.

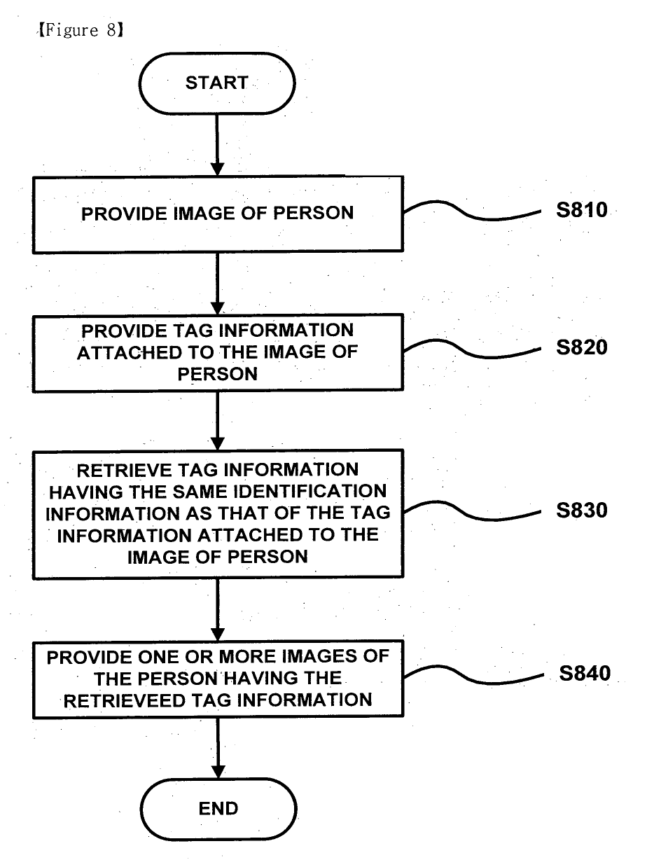

FIG. 8 illustrates a process of retrieving images of a person based on the tag information in accordance with still another example embodiment of the present invention.

At step S810, an image of a specific person is provided. The image of the specific person may be acquired by either directly taking a picture of the specific person by using the service device itself or indirectly receiving it from other devices outside of the service device. Herein, the tag information may or may not have been attached to the acquired image.

Subsequently, the tag information corresponding to the image of the specific person is acquired (step S820).

In case the image of the specific person already has the tag information attached thereto), the service device retrieves the tag information having been attached to the image of the specific person from a database, to thereby acquire the retrieved tag information.

However, in case there is no tag information having been attached to the image of the specific person, the service device can acquire the tag information through a similar process as described by referring to FIG. 2.

Once the tag information corresponding to the image of the specific person is acquired, the service device may retrieve from the database other tag information having the same identification information as that included in the acquired tag information (step S830).

The identification information on the specific person may include a name, a mail address, a telephone number, an email address, a nickname and the like.

Thereafter, the service device may provide one or more images having the tag information acquired at the step of S820 or S830 (step S840).

While the present invention has been shown and described with respect to the preferred embodiments, it will be understood by those skilled in the art that various changes and modifications may be made without departing from the spirit and the scope of the present invention as defined in the following claims.

1. A method for transmitting an electronic image of a person based on tag information, comprising the steps of:
acquiring an image of a person;
retrieving a contact information related to the person from tag information associated with the electronic image of the person; and
transmitting the electronic image of the person by using the retrieved contact information.

2. The method of claim 1, wherein the step of retrieving the contact information comprises the steps of:
retrieving from a database one or more candidates having high probabilities of being determined as the person and displaying the retrieved candidates on a screen of a user;
providing the user with a pointing service capable of selecting a candidate among the displayed candidates; and
retrieving the contact information from tag information associated with the candidate if the candidate is selected by the pointing service.

3. The method of claim 1, wherein the step of retrieving the contact information comprises the step of retrieving the contact information from the tag information recorded in a database.

4. (canceled)

5. The method of claim 1, wherein the contact information includes at least one of an email address, a telephone number, a web service ID, a fax number, and a residence address.

6. A method for displaying an electronic image of a caller based on tag information, comprising the steps of:
receiving a call from a caller;
retrieving tag information corresponding to the caller; and
displaying one or more electronic images corresponding to the retrieved tag information.

7. The method of claim 6, wherein the call includes at least one of a telephone call, an SMS, a mobile email, and an MMS.

8. The method of claim 6, wherein, if a plurality of electronic images corresponding to the retrieved tag information exist, the step of displaying the electronic images comprises the step of displaying an electronic image having the latest updated tag information in relation to the call among the plurality of electronic images.

9. The method of claim 6, wherein, if a plurality of electronic images corresponding to the retrieved tag information exist, the step of displaying the electronic images comprises the step of displaying the plurality of electronic images one by one at regular intervals.

10. The method of claim 6, wherein, if a plurality of electronic images corresponding to the retrieved tag information exist, the step of displaying the electronic images comprises the steps of:
selecting an electronic image, which has not been displayed for the longest time in relation to the call, among the plurality of electronic images;
displaying the selected electronic image; and
recording an indication that the selected electronic image being used in relation to the call.

11. The method of claim 6, wherein the retrieved tag information includes the caller's telephone number.

12. The method of claim 6, wherein the step of retrieving the tag information corresponding to the call of the caller comprises the steps of:
acquiring identification information which has relation to the caller's telephone number;
and
retrieving the tag information including the identification information.

13. A method for displaying an electronic image of a callee based on tag information, comprising the steps of:
transmitting a call to a callee;
retrieving tag information which corresponds to the call; and
displaying one or more electronic images corresponding to the retrieved tag information.

14. The method of claim 13, wherein the call includes at least one of a telephone call, an SMS, a mobile email and an MMS.

15. The method of claim 13, wherein, if a plurality of electronic images corresponding to the retrieved tag information exist, the step of displaying the electronic images comprises the step of displaying an electronic image having the latest updated tag information in relation to the call among the plurality of electronic images.

16. The method of claim 13, wherein, if a plurality of electronic images corresponding to the retrieved tag information exist, the step of displaying the electronic images comprises the step of displaying the plurality of electronic images one by one at regular intervals.

17. The method of claim 13, wherein, if a plurality of electronic images corresponding to the retrieved tag information exist, the step of displaying the electronic images comprises the steps of:
selecting an electronic image, which has not been displayed for the longest time in relation to the call, among the plurality of electronic images;
displaying the selected electronic image; and
recording an indication that the selected electronic image being used in relation to the call.

18. The method of claim 13, wherein the retrieved tag information includes the callee's telephone number.

19. The method of claim 13, wherein the step of retrieving the tag information corresponding to the call comprises the steps of:
acquiring identification information which has relation to the callee's telephone number;
and
retrieving the tag information including the identification information.

20. A method for retrieving one or more electronic images of a person based on tag information from a database where a plurality of electronic images are recorded, comprising the steps of:
providing an electronic image of a person;
acquiring first tag information corresponding to the electronic image of the person;
retrieving second tag information having the same identification information as that of the acquired first tag information; and
providing one or more electronic images corresponding to the first or the second tag information.

21. The method of claim 20, wherein the step of providing the electronic image of the person comprises the step of creating the electronic image; and the step of acquiring the first tag information comprises the steps of:
retrieving from a database a plurality of candidates having high probabilities of being determined as the person included in the created electronic image and displaying the retrieved candidates;
providing a user with a pointing service capable of selecting a candidate among the displayed candidates; and
retrieving identification information from tag information having been attached to the candidate if the candidate is selected by the pointing service, and providing the retrieved identification information so as to be included in the first tag information.

22. The method of claim 20, wherein the step of providing the electronic image of the person comprises the step of retrieving the electronic image from the database; and wherein the step of acquiring the first tag information comprises the step of retrieving tag information which has been attached to the electronic image.

23. The method of claim 20, wherein the identification information on the person includes at least one of a name, a mail address, an email address, a telephone number and a nickname.

24. (canceled)
